(19) United States
(12) Patent Application Publication
(10) Pub. No.: US 2007/0194691 A1
(43) Pub. Date: Aug. 23, 2007

(54) Light emitting diode package structure having high light extraction efficiency and method of manufacturing the same

(75) Inventors: Ho Sung Choo, Suwon (KR); Youn Gon Park, Suwon (KR); Hai Sung Lee, Suwon (KR); Myung Whun Chang, Seoul (KR); Jong Myeon Lee, Gyunggi-Do (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/708,466

(22) Filed: Feb. 21, 2007

(30) Foreign Application Priority Data
Feb. 21, 2006 (KR) 10-2006-0016701

(51) Int. Cl. H01J 1/62

(52) U.S. Cl. 313/502

(57) ABSTRACT

In a light emitting diode package, a package substrate includes a mounting area, an electrode and a light emitting diode chip disposed on the mounting area. A phosphor film encapsulates the light emitting diode chip in an upward convex configuration. A resin encapsulant encapsulates the phosphor film in an upward convex configuration. The light emitting diode package prevents light loss which arises from increased light scattering due to dense phosphors, thereby achieving excellent light extraction efficiency. Also, a phosphor film is formed by dispensing, thereby leading to no breaking of an upper wire even in a face-up chip.

### CLAIM OF PRIORITY

This application claims the benefit of Korean Patent Application No. 2006-16701 filed on Feb. 21, 2006 in the Korean Intellectual Property Office, the disclosure of which is incorporated herein by reference.

### BACKGROUND OF THE INVENTION

1. Field of the Invention

The present invention relates to a light emitting diode package structure with high light extraction efficiency and a manufacturing method thereof, and more particularly, to a light emitting diode package having an upper hemispheric phosphor film formed by dispensing to change a wavelength of a light emitting diode emitting a short wavelength.

2. Description of the Related Art

In general, a light emitting diode is superior in monochromatic peak wavelength and light efficiency, and miniaturizable. Accordingly, the light emitting diode (LED) is widely utilized in various display devices and as light sources. Notably, a white light emitting diode is actively being developed as a high power and high efficiency light source which can replace a lightening device or a display device.

Unlike backlight units (BLUEs), which are one of major applications of the LED, the lightening device is less spatially limited. Thus, diverse attempts have been made on an LED package to enhance brightness and optical effects, as is exemplified by methods for controlling refractivity of an encapsulant, configuring a lens and forming a phosphor film.

In a recent attempt to improve light extraction efficiency, as shown in FIG. 1, a phosphor film 17 is applied around a light emitting diode chip 11 by stencil printing. In this structure where the phosphor film 17 is applied around the light emitting diode chip 11, a light emitting point is located in a center of curvature O of a top surface 18, i.e., an outermost surface of a resin encapsulant when a blue light from the light emitting diode chip 11 is converted into a yellow light. Therefore, this structure allows light to be extracted from a resin with high refractivity into the air.

As described above, the phosphor film 17 is applied around the light emitting diode chip 11. This mainly allows light to enter an interface 16 between the resin encapsulant 19 and the phosphor film 17 substantially perpendicularly, thereby elevating light extraction efficiency of the light emitting diode.

To achieve this object, all light emitting points should be located in the center of curvature O of the refractive interface 16. However, the light emitting diode chip 11 is not configured as a point but two-dimensional. Thus, the light emitting point deviates from the center of curvature O of the phosphor film 17 which is applied around the light emitting chip 11, thereby failing to obtain adequate light extraction effects.

Also, phosphors are very dense in this structure so that light passing through the phosphor film 17 suffers scattering and loss. This adversely affects light extraction efficiency.

Moreover, the phosphor film 17 applied around the light emitting diode chip 11 can be formed by stencil printing, thus only applicable to a flip chip LED package. The phosphor film 17, if applied to a face-up chip LED package of a wire bonding structure, which currently predominates, causes an upper wire to break during printing.

### SUMMARY OF THE INVENTION

The present invention has been made to solve the foregoing problems of the prior art and therefore an aspect of the present invention is to provide a light emitting diode package structure with a phosphor film which minimizes light loss from light scattering and assures superior light extraction efficiency.

Another aspect of the invention is to provide a method for manufacturing a phosphor film which is applicable to both a flip chip and a face-up chip of a wire bonding structure.

According to an aspect of the invention, the light emitting diode package includes a package substrate having a mounting area, an electrode and a light emitting diode chip disposed on the mounting area; a phosphor film encapsulating the light emitting diode chip in an upward convex configuration; and a resin encapsulant encapsulating the phosphor film in an upward convex configuration.

Preferably, the phosphor film has a curvature identical to that of the resin encapsulant. More preferably, the phosphor film and the resin encapsulant are hemispherical, respectively. Most preferably, the phosphor film has a center of a curvature identical to that of the resin encapsulant.

The light emitting diode chip may be a flip chip. Alternatively, the light emitting diode chip may be a face-up chip, the light emitting diode package further including a wire for electrically connecting the light emitting diode chip with lead frames.

Moreover, the phosphor film may be a droplet of a phosphor paste dispersed in the light emitting diode chip, the paste including a transparent polymer resin and a phosphor powder dispersed in the transparent polymer resin. The transparent polymer resin is made of one selected from a group consisting of an epoxy resin, a silicone resin and mixtures thereof.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating a conventional light emitting diode package of a flip chip structure in which a phosphor film is applied on an LED chip by a stencil process;

FIG. 2 is a schematic view illustrating a light emitting diode package of a flip chip structure according to the invention;

FIG. 3 is a schematic view illustrating a light emitting package of a face-up chip structure which has a center of curvature located in a light emitting diode chip; and

FIG. 4 illustrates an exemplary method for manufacturing a light emitting diode package with a phosphor film.

### DETAILED DESCRIPTION OF THE PREFERRED EMBODIMENT

Exemplary embodiments of the present invention will now be described in detail with reference to the accompanying drawings.

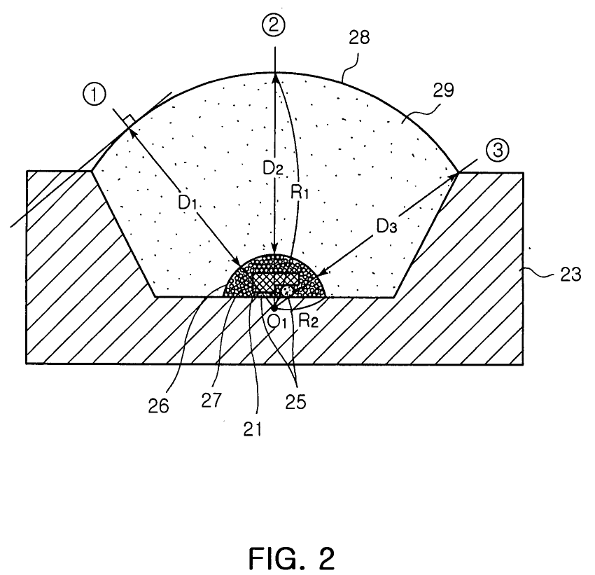

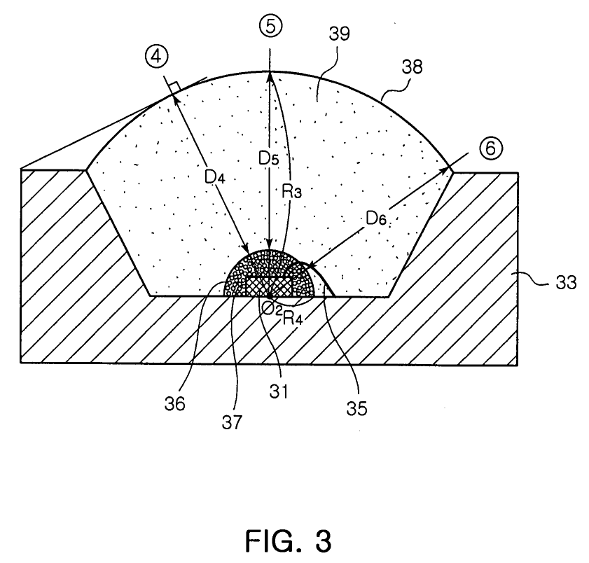

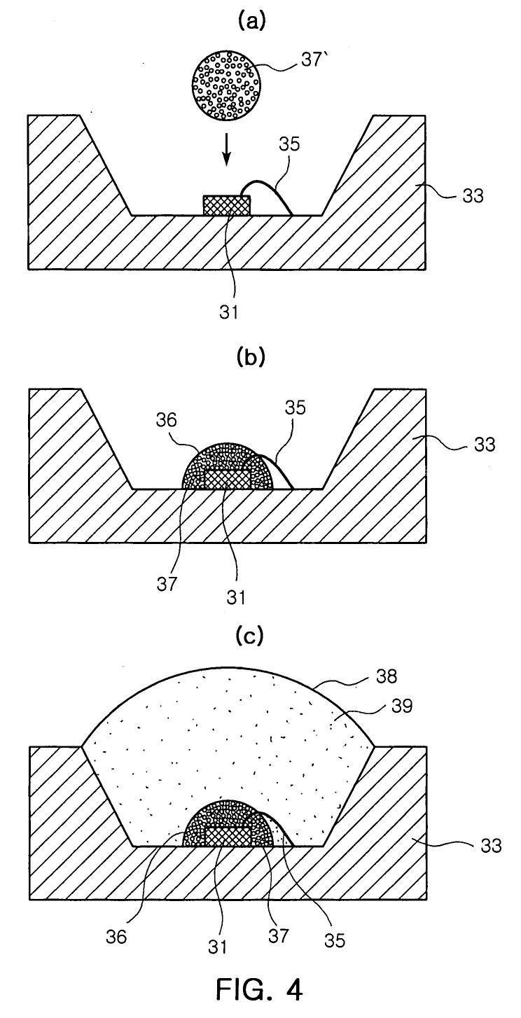

FIG. 2 is a schematic view illustrating a light emitting diode package with a phosphor film according to the invention, in which a light emitting diode chip is configured as a flip chip, and a center of curvature of a refractive interface is identical to that of a top surface of a resin encapsulant. FIG. 3 is a schematic view illustrating a light emitting diode package with a phosphor film according to the invention, in which a light emitting diode chip is configured as a face-up chip, and centers of curvature of both a refractive interface and a top surface of a resin encapsulant are located in the light emitting diode chip. FIG. 4 is a schematic view illustrating an exemplary method for manufacturing a light emitting diode with a phosphor film.

A light emitting diode package according to an embodiment of the invention includes a mounting area, an electrode, and a light emitting diode chip 21 disposed on the mounting area. That is, a flip chip is disposed on a package substrate 23. A phosphor film 27 is disposed on the package substrate 23 to encapsulate the light emitting diode chip 21. The phosphor film 27 is upwardly convexed. Also, a resin encapsulant 29 encapsulates the phosphor film 27 also in an upward convex configuration.

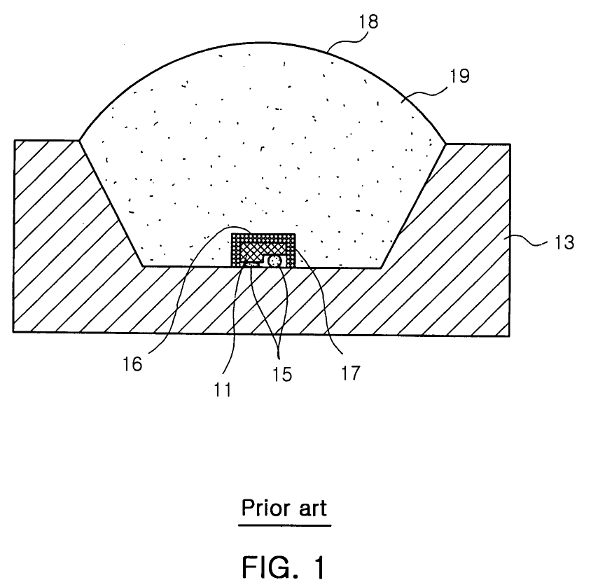

As described above, the phosphor film 27 is formed in an upward convex configuration. This ensures phosphors to be distributed around the light emitting diode chip 21 in a larger area. Accordingly, the phosphors can be reduced in density compared to a case where the phosphor film 17 is formed by a stencil process according to the prior art. This as a result provides a path for light to exit more easily than the prior art as shown in FIG. 1. That is, the phosphors are distributed in a larger area to lower density thereof, thereby diminishing light loss from light scattering. This increases light extraction efficiency after all.

The phosphor film 27 and the resin encapsulant 29 may have an upward convex configuration with the same curvature. More preferably, the upward convex configuration features an upper hemisphere.

The phosphor film 27 is sized to fully encapsulate the light emitting diode chip 21. Preferably, a curvature radius R₂ of the phosphor film 27 is greater than a distance from a center of curvature O₁ to a corner of the light emitting diode chip 21, and smaller than a curvature radius R₁ of the resin encapsulant 29. Also, on lines □, □ and □ connecting the center of curvature O₁ to certain points on a top surface 28 of the resin encapsulant, distances D₁, D₂and D₃ between the refractive interface 26 and the top surface 28 of the resin encapsulant can be equal. That is, D₁=D₂=D₃.

Furthermore, the center of curvature of the hemispherical phosphor film 27 may be identical to that O₁ of the hemispherical resin encapsulant 29. Such an identical center of curvature O₁ allows light to enter the refractive interface 26, i.e., a boundary between the resin encapsulant 29 and the phosphor film 27 substantially perpendicularly, thereby more enhancing light extraction efficiency.

According to a most preferred embodiment of the invention, as shown in FIG. 3, the top surface 36 of the phosphor film and the top surface 38 of the resin encapsulant are hemispherical, respectively so that the center O₂ of curvature of the refractive interface 36 and that O₂ of the top surface 38 of the resin encapsulant are located in the light emitting diode chip 31, respectively.

The phosphor film 37 is sized to fully encapsulate the light emitting diode chip 31. Here, a curvature radius R₄ of the phosphor film 37 is greater than a distance from the center of curvature O₂ to a corner of the light emitting diode chip 31, and smaller than a curvature radius R₃ of the resin encapsulant 39. Moreover, on lines □,□ and □ connecting the center of curvature O₂ to certain points on the top surface 38 of the resin encapsulant, distances D₄,D₅,D₆ between the refractive interface 36 and the top surface 38 of the resin encapsulant 38 are equal. That is, D₄=D₅=D₆.

The light emitting diode chip 31 is not configured as a point but two-dimensional. But the light emitting diode chip 31 is disposed in the center of curvature O₂ of the refractive interface 36 and the top surface 38 of the resin encapsulant. Thus, in an optical sense, the light emitting diode chip serves as a point light source. Furthermore, light radiated from the light emitting diode chip 31 can reach the refractive interface 36 and the top surface 38 of the resin encapsulant substantially perpendicularly.

In the conventional light emitting diode package structured as in FIG. 1, the center of curvature O of the resin encapuslant 19 lies in the light emitting diode. However, the center of curvature O of the phosphor film 17 deviates from the light emitting diode so that the resin encapsulant is required to have a curvature for compensating for such deviation to ensure light extraction efficiency. The light emitting diode package with the phosphor film 27 and 37 as shown in FIGS. 2 and 3 can minimize light loss from light scattering and improve light extraction efficiency.

Further, a brief explanation will be given about a method for manufacturing a light emitting diode with a phosphor film 27 and 37 with reference to FIG. 4.

A light emitting diode chip 31 is attached onto a package by eutectic soldering, and lead frames are wire bonded to the light emitting diode chip 31 through a wire 35 to be electrically connected with each other. Then a phosphor paste, which contains a transparent polymer resin and a phosphor powder dispersed in the transparent polymer resin at an adequate ratio, is dispensed over the light emitting diode chip 31 at a predetermined amount.

Here, a droplet 37′ of the phosphor paste as depicted in FIGS. 4a and 4b can be adopted for dispensing. This dispensing process ensures the light emitting diode chip to be applicable to an LED package of not only a flip chip structure but also a face-up structure.

By the conventional stencil printing, a wire 35 is installed in advance to electrically connect the lead frames (not illustrated) to the light emitting diode chip 31, but likely to be breakable during printing. On the other hand, according to the invention, the droplet 37′ of the phosphor paste is dispensed over the light emitting diode chip 31 to form the phosphor film 37. This does not cause any breaking of the wire 35 as described above.

Subsequently, the phosphor paste dispensed over the light emitting diode chip 31 is cured. Here, curing time and temperature can be varied with viscosity of the phosphor paste and an amount of the droplet 37′ depending on a desired hemispheric shape. Moreover, dispensing height, time and temperature necessary for curing of the phosphor paste are adjusted in accordance with viscosity of the paste and the dispensing amount of the droplet 37′, thereby forming the paste into a desired shape. The viscosity and dispensing amount are adjusted as described above so that the center of curvature of the hemispherical phosphor film 37 is identical to the center of curvature O₂ of the top surface 38 of the resin encapsulant.

After the phosphor paste is cured to form the phosphor film 37, a transparent polymer resin with no phosphor powder dispersed therein is dispensed on the phosphor film 37 to form the resin encapsulant 39. Then, the resin encapsulant 39 is cured to produce a light emitting diode package of the invention.

In addition, the resin encapsulant 39 is made of a transparent polymer resin with no phosphor powder dispersed therein. The transparent polymer resin is selected from a group consisting of an epoxy resin used as a matrix of the phosphor film 37, a silicone resin and mixtures thereof.

As set forth above, according to exemplary embodiments of the invention, a top surface of a phosphor film has a dome configuration with a curvature identical to that of a top surface of a resin mold, thereby assuring higher light extraction efficiency. This also minimizes light loss from light scattering, thereby realizing a general lightening source to illuminate uniform colors free from color stains.

In addition, according to the invention, a droplet of a phosphor paste is dispensed, thus not causing any breaking of an upper wire unlike as in the conventional stencil process. Thus, the invention is applicable to a light emitting diode package of not only a flip chip structure but also a face-up chip structure.

While the present invention has been shown and described in connection with the preferred embodiments, it will be apparent to those skilled in the art that modifications and variations can be made without departing from the spirit and scope of the invention as defined by the appended claims.

What is claimed is:

1. A light emitting diode package comprising:
a package substrate including a mounting area, an electrode and a light emitting diode chip disposed on the mounting area;
a phosphor film encapsulating the light emitting diode chip in an upward convex configuration; and
a resin encapsulant encapsulating the phosphor film in an upward convex configuration.

2. The light emitting diode package according to claim 1, wherein the phosphor film has a curvature identical to that of the resin encapsulant.

3. The light emitting diode package according to claim 1, wherein the phosphor film and the resin encapsulant are hemispherical, respectively.

4. The light emitting diode package according to claim 1, wherein the phosphor film has a center of a curvature identical to that of the resin encapsulant.

5. The light emitting diode package according to claim 4, wherein the center of the curvature is located in the light emitting diode chip.

6. The light emitting diode package according to claim 1, wherein the light emitting diode chip comprises a flip chip.

7. The light emitting diode package according to claim 1, wherein the light emitting diode chip comprises a face-up chip,
the light emitting diode package further comprising a wire for electrically connecting the light emitting diode chip with lead frames.

8. The light emitting diode package according to claim 1, wherein the phosphor film comprises a droplet of a phosphor paste dispersed in the light emitting diode chip, the paste comprising a transparent polymer resin and a phosphor powder dispersed in the transparent polymer resin.

9. The light emitting diode package according to claim 8, wherein the transparent polymer resin comprises one selected from a group consisting of an epoxy resin, a silicone resin and mixtures thereof.
